(19) United States
(12) Patent Application Publication
(10) Pub. No.: US 2007/0045055 A1
(43) Pub. Date: Mar. 1, 2007

(54) Stroller with a brake assembly

(76) Inventor: Red Lan, Taipei Hsien (TW)

Correspondence Address: WHYTE HIRSCHBOECK DUDEK S C, 555 EAST WELLS STREET, SUITE 1900, MILWAUKEE, WI, 53202, US

(21) Appl. No.: 11/211,263

(22) Filed: Aug. 25, 2005

(51) Int. Cl. B62B 9/08

(52) U.S. Cl. 188/20; 188/31

(57) ABSTRACT

A stroller includes a tubular member disposed between left and right wheel axles and extending along a rotating axis, a linking rod rotatably mounted in the tubular member and having two linking ends which extend outwardly of the tubular member to connect with two brake control seats, a brake pedal rotatably mounted on the tubular member and extending rearwardly to be connected to the linking rod by a coupling member such that treading of the pedal forces the coupling member to turn so as to synchronously rotate the brake control seats between non-actuating and actuating positions. Two braking mechanisms are mounted between the brake control seats and the wheel axles. Each braking mechanism has a braking member moved toward a wheel when the brake control seat is turned to the actuating position so as to restrain rotation of the wheel relative to the wheel axle.

### BACKGROUND OF THE INVENTION

1. Field of the Invention

This invention relates to a stroller, more particularly to a stroller having a brake pedal which can actuate two braking mechanisms to restrain rotation of two rear wheels.

2. Description of the Related Art

Referring to FIGS. 1 to 3, in U.S. Pat. No. 6,742,791, entitled “Stroller With Spring-biased Brake Pins,” there is disclosed a stroller 1 which includes a frame 11, two rear wheel units 12 mounted to lower ends of two rear legs 111 of the frame 11, and a brake assembly 2. Each of the rear wheel units 12 has an axle 121 and an engaging seat 122 which is rotatably mounted on the axle 121 and which has a plurality of engaging grooves 123 angularly displaced from one another about the axle 121. The brake assembly 2 includes a pedal-mounting rod 21 mounted between the rear legs 111, a brake pedal 22 rotatably mounted on the pedal-mounting rod 21, two brake mechanisms 23 disposed adjacent to the rear wheel units 12, respectively, a mounting rod 24 disposed between mounting seats 231 of the brake mechanisms 23, and a pair of push rods 25 movably disposed on an intermediate portion of the mounting rod 24. The brake pedal 22 has a pivot portion 221 sleeved rotatably on the pedal-mounting rod 21, a foot-engaging portion 222 extending rearward from the pivot portion 221, and a control portion 223 extending forward from the pivot portion 221 for extension of the mounting rod 24 therethrough. The control portion 223 has a small-width portion 224 and a large-width portion 225. Each of the push rods 25 has a driven end 251 abutting against the control portion 223, and a coupling end 253 movably engaging the mounting seat 231 by means of a positioning pin 252. Each brake mechanism 23 further has a brake pin 232 which is movably mounted in the mounting seat 231, a spring 233 which is sleeved on the brake pin 232 to push the same to engage one of the engaging grooves 123, and a positioning pin 234 which interconnects the spring 233 and the positioning pin 234.

When the stroller 1 is in a non-braked position as indicated by solid lines in FIG. 3, the brake pin 232 is retracted into the mounting seat 231, and the small-width portion 224 of the pedal 22 is disposed between the driven ends 251 of the push rods 25. When the foot-engaging portion 222 of the pedal 22 is treaded to turn the large-width portion 225, the push rods 25 are pushed outwardly to move the springs 233 outwardly, as indicated by dotted lines in FIG. 3, thereby moving the positioning pin 234 and the brake pin 232 to engage a selected one of the engaging grooves 123 so as to bring the stroller 1 into a braked position for preventing rotation of the engaging seats 122 of the wheels 12.

Such a conventional stroller 1 has a relatively large number of component parts, and is therefore costly to manufacture and inconvenient to assemble. Besides, many component parts of the brake assembly 2, such as the brake pedal 22, the pedal-mounting rod 21, the two push rods 25, and the mounting rod 24, are exposed on the outside, which renders the outer appearance of the stroller 1 complicated.

### SUMMARY OF THE INVENTION

The object of the present invention is to provide a stroller which has a braking assembly, that has a simple construction, that is easy and inexpensive to fabricate and assemble, and that has a simple outer appearance.

According to this invention, the stroller comprises left and right wheel units which respectively have left and right wheel axles extending along a wheel axis in a longitudinal direction, and left and right wheels rotatably mounted on the left and right wheel axles, respectively. A mounting frame is disposed between the left and right wheel axles, and has a tubular member including a surrounding wall that defines a channel and that extends along a rotating axis parallel to the wheel axis, and an elongate slot that extends through the surrounding wall and that is elongated angularly about the rotating axis. A linking rod is rotatably mounted in the channel to be rotated about the rotating axis, and has two linking ends opposite to each other in the longitudinal direction and extending outwardly of the channel, respectively. Two brake control seats are respectively connected to the linking ends to be rotated therewith about the rotating axis. A brake pedal has a pivot portion which is rotatably mounted on the tubular member, and a foot-engaging portion which extends from the pivot portion in a transverse direction relative to the longitudinal direction. A coupling member has an inner portion which is disposed in the channel and which extends radially from the linking rod, and an outer portion which extends from the inner portion and outwardly of the surrounding wall through the elongate slot such that treading of the foot-engaging portion forces the outer portion of the coupling member to turn about the rotating axis along the elongate slot so as to synchronously rotate the brake control seats about the rotating axis between a non-actuating position and an actuating position. Two braking mechanisms are mounted between the brake control seats and the left and right wheel axles, respectively. Each of the braking mechanisms includes a braking member that is disposed to be moved in the transverse direction such that when the respective one of the brake control seats is turned from the non-actuating position to the actuating position, the braking member is moved toward the respective one of the left and right wheels so as to restrain rotation of the left and right wheels relative to the left and right wheel axles.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a fragmentary perspective view of a conventional stroller disclosed in UK Patent Publication No. GB2380235;

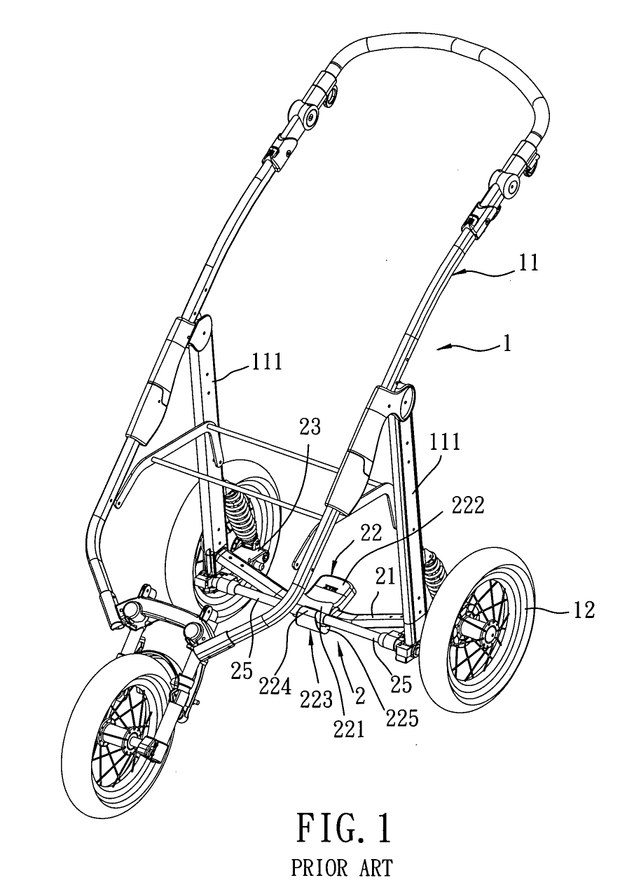

FIG. 2 is a partly exploded fragmentary perspective view of a brake assembly of the conventional stroller;

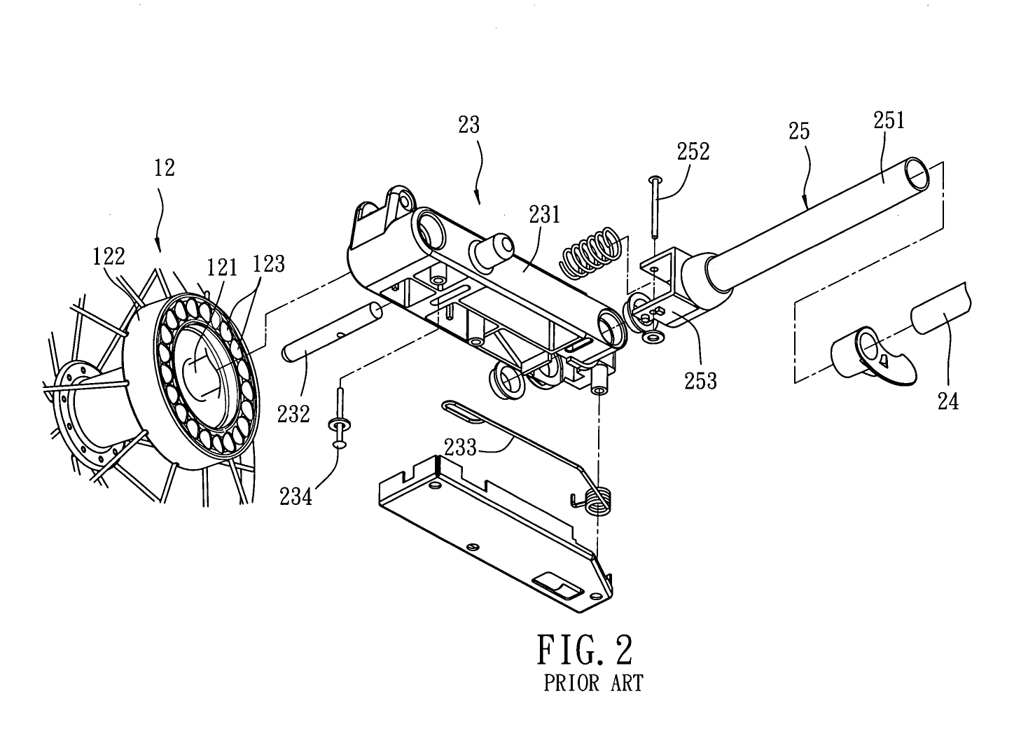

FIG. 3 is a schematic fragmentary bottom view of the brake assembly of the conventional stroller;

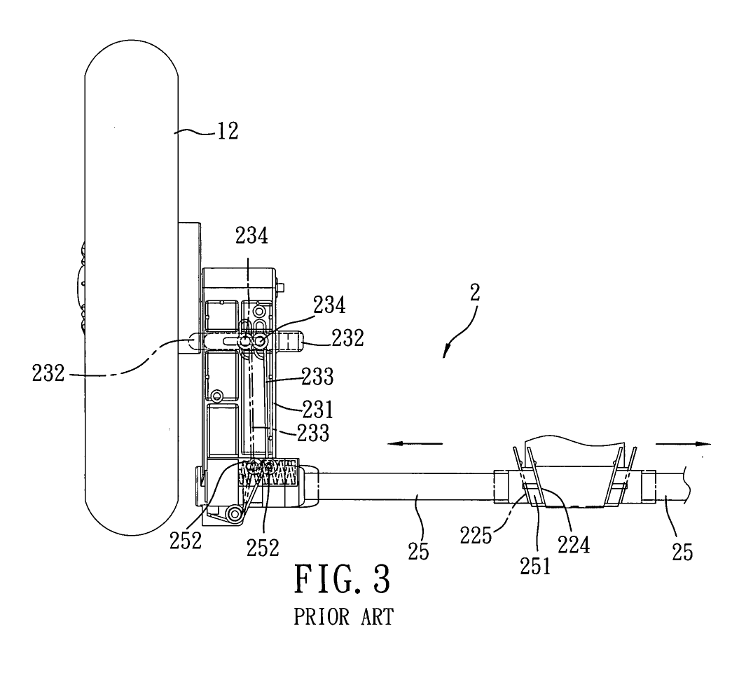

FIG. 4 is a partly exploded fragmentary perspective view of the preferred embodiment of a braking assembly of a stroller according to this invention;

FIG. 5 is a schematic fragmentary side view of the preferred embodiment;

FIG. 6 is a partly sectioned fragmentary schematic view of a pedal unit of the brake assembly of the preferred embodiment;

FIG. 7 is a fragmentary perspective view of a brake mechanism of the brake assembly of the preferred embodiment;

FIG. 8 is a fragmentary exploded perspective view of the brake mechanism of the brake assembly of the preferred embodiment;

FIG. 9 is a partly sectioned fragmentary schematic view of the braking mechanism when the pedal unit is in the state shown in FIG. 6;

FIG. 10 is a view similar to FIG. 6, but showing the pedal unit in another state; and

FIG. 11 is a view of the braking mechanism similar to FIG. 9, but the pedal unit in the state shown in FIG. 10.

### DETAILED DESCRIPTION OF THE PREFERRED EMBODIMENT

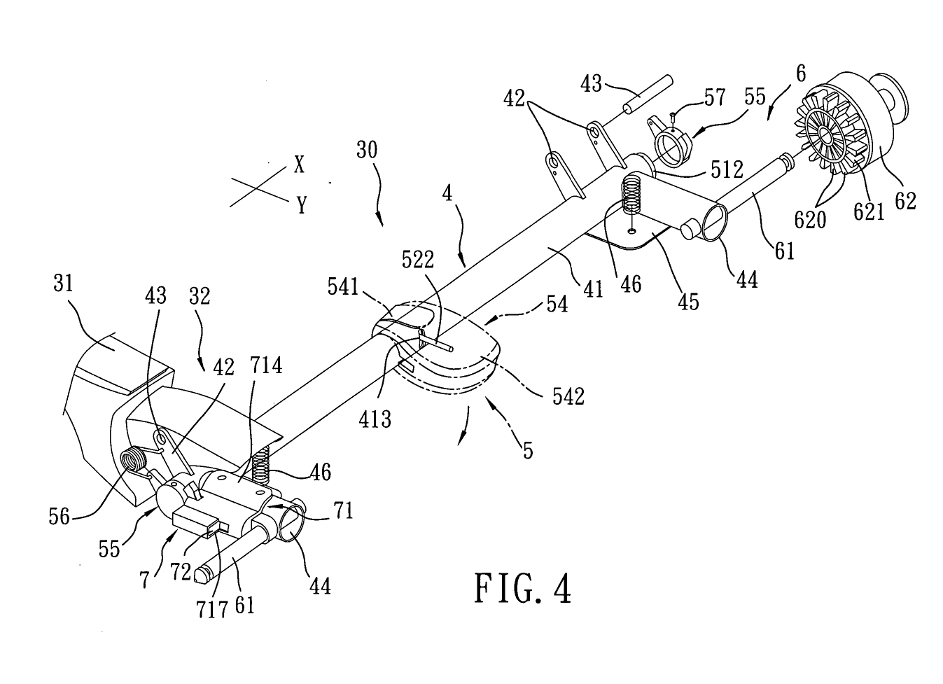

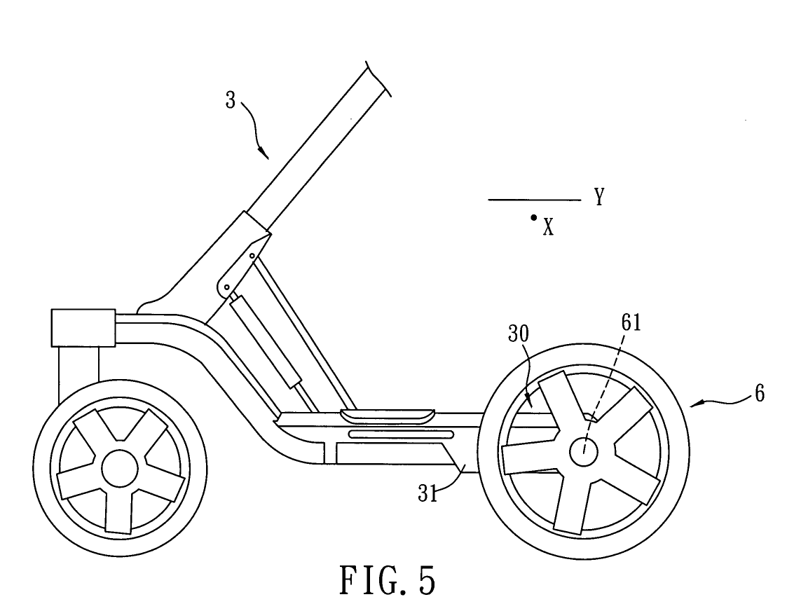

Referring to FIGS. 4 and 5, the preferred embodiment of a stroller 3 according to the present invention is shown to comprise left and right frame bodies 31 which are opposite to each other in a longitudinal direction (X) and which respectively have left and right pivot portions 32 that are proximate to rear left and right wheel units 6, respectively, and a brake assembly 30 which is disposed between the left and right pivot portions 32. The left and right wheel units 6 respectively have left and right wheel axles 61 extending along a wheel axis in the longitudinal direction (X), and left and right wheels 62 rotatably mounted on the left and right wheel axles 61, respectively.

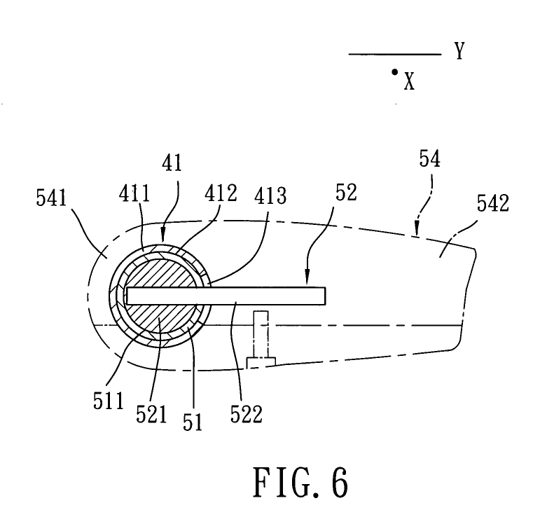

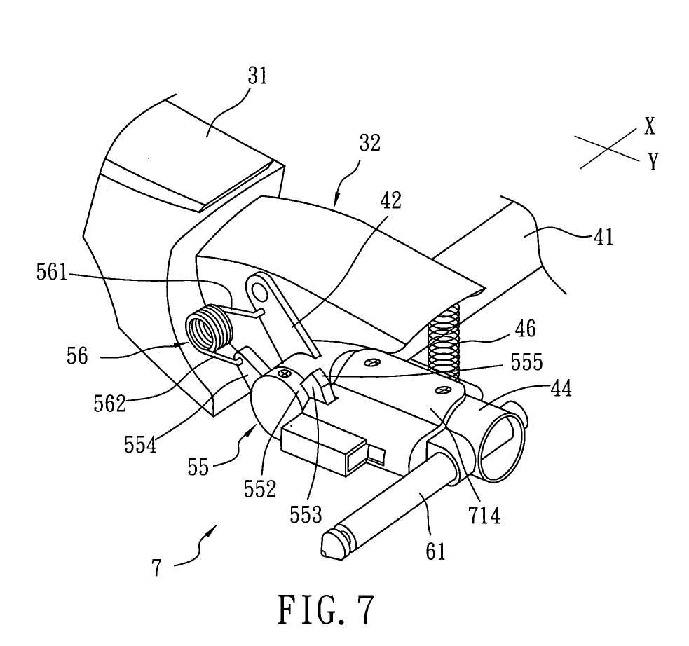

With reference to FIGS. 4, 6 and 7, the brake assembly 30 includes a mounting frame 4, a pedal unit 5, and two braking mechanisms 7.

The mounting frame 4 has a circular cross-sectioned tubular member 41 which includes a surrounding wall 411 that defines a channel 412 and that extends along a rotating axis parallel to and offset from the wheel axis, and an elongate slot 413 that extends through the surrounding wall 411 and that is elongated angularly about the rotating axis, left and right pivoting lug units 42 which are mounted on the tubular member 41 and which are respectively proximate to the left and right wheel units 6 so as to be pivotally mounted on the left and right pivot portions 32, respectively, by means of pivot pins 43 about a pivot axis in the longitudinal direction, left and right axle mounting members 44 which extend rearwardly from the tubular member 41 to engage the left and right wheel axles 61, and left and right support plates 45 which are disposed between the tubular member 41 and the axle mounting members 44. Two damping springs 46 are disposed between the left and right pivot portions 32 and the left and right support plates 45.

The pedal unit 5 includes a hollow linking rod 51 which is rotatably mounted in the channel 412 to be rotated about the rotating axis, and which has two linking ends 512 opposite to each other along the rotating axis and extending outwardly of the channel 412, respectively, a coupling member 52 which has an inner portion 521 that is disposed in an axial duct 511 in the linking rod 51 and that extends radially from the linking rod 51, and an outer portion 522 that extends from the inner portion 521 and outwardly of the surrounding wall 411 through the elongate slot 413, and a brake pedal 54 which has a pivot portion 541 that is rotatably mounted on the tubular member 41, and a foot-engaging portion 542 that extends from the pivot portion 541 in a transverse direction (Y) relative to the longitudinal direction (X) and that is securely connected to the outer portion 522 of the coupling member 52.

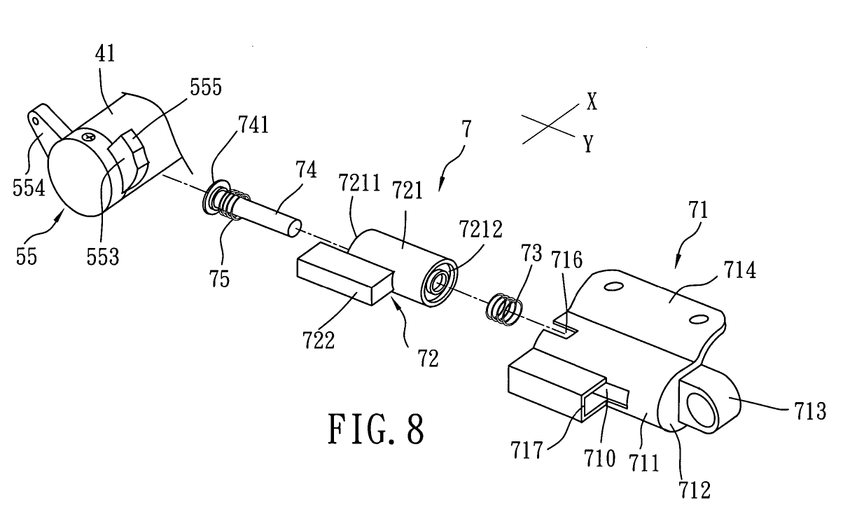

Referring to FIGS. 4, 7 and 8, each of the braking mechanisms 7 includes a plurality of engaging grooves 621, a brake control seat 55, a cam 553, a brake mounting seat 71, a braking member 72, a return spring 73, a press rod 74, and a press spring 75.

The engaging groves 621 are formed in a respective one of the left and right wheels 62, are defined by a plurality of ribs 620, and are angularly displaced from one another about the wheel axis. The brake control seat 55 is connected to the respective linking end 512 of the linking rod 51 by means of a screw 57 for rotation therewith about the rotating axis, and includes a peripheral wall 552 surrounding the rotating axis, and a spring mounting portion 554 extending radially from the peripheral wall 552. A torsion spring 56 has first and second spring ends 561, 562 which are respectively connected to the respective pivoting lug unit 42 and the spring mounting portion 554 of the brake control seat 55. The cam 553 extends radially from the peripheral wall 552, and has a cam surface 555 which includes first and second areas that are angularly displaced from each other about the rotating axis. The brake mounting seat 71 is disposed between the brake control seat 55 and the wheel axle 61, and has a chamber wall 711 defining a chamber 710 therein, a rear end wall 712 connected to a rear end of the chamber wall 711, a lug 713 extending from the rear end wall 712 for passage of the wheel axle 61, and two wings 714 mounted securely and respectively on the respective axle mounting member 44. The chamber wall 711 has a notch 716 for insertion of the cam 553, and a projection port 717 adjacent to the wheel axle 61.

The braking member 72 is movably mounted in the chamber 710 in the transverse direction (Y), and has a forced portion 721 and an engaging portion 722 which respectively extend along first and second axes in the transverse direction (Y), and which are respectively proximate to the cam 553 and the projection port 717. The forced portion 721 has abutted and abutting ends 7211, 7212 opposite to each other along the first axis. The return spring 73 is disposed between the abutting end 7212 and the rear end wall 712 so as to bias the abutted end 7211 toward the cam 553. The press rod 74 has a pressed end 741 which engages and which is depressable by the cam surface 555. The press spring 75 is disposed between the cam surface 555 and the abutted end 7211 of the forced portion 721 so as to press the forced portion 721 to move the engaging portion 722 toward the wheel axle 61. As shown in FIGS. 4, 6 and 9, when the brake assembly 30 is in a non-braking position, the outer portion 522 of the coupling member 52 is in an upper position of the elongate slot 413, the brake control seat 55 is in a non-actuating position to permit the first area of the cam surface 555 to engage the pressed end 741 of the press rod 74, and the engaging portion 722 is retracted completely into the chamber 710 so as to disengage from any one of the engaging grooves 621, thereby permitting rotation of the wheel 62 relative to the wheel axle 61.

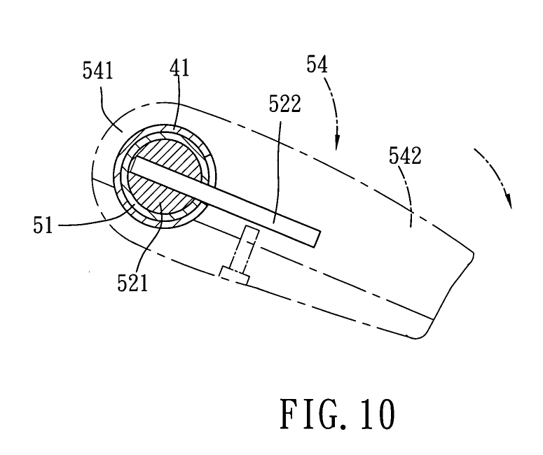

As shown in FIGS. 4, 10 and 11, when the foot-engaging portion 542 of the brake pedal 54 is treaded to shift the brake assembly 30 to a braking position, the outer portion 522 of the coupling member 52 is forced to turn relative to the tubular member 41 about the rotating axis along the elongate slot 413 to synchronously rotate the brake control seats 55 about the rotating axis to an actuating position. The cam surface 555 is rotated to permit the second area to engage the pressed end 741 of the press rod 74 so as to force the press spring 75 against the abutted end 7211 of the forced portion 721 such that the engaging portion 722 is moved along the second axis to extend through the projection port 717 to be inserted into a selected one of the engaging grooves 621, thereby restraining the rotation of the wheel 62 relative to the wheel axle 61 for braking the stroller 3.

When the pedal 54 is released, the brake control seats 55 are rotated from the actuating position to the non-actuating position, and the pressed end 741 is forced towards the brake control seat 55 through the press spring 75.

It is noted that the press spring 75 is disposed for providing a resilient force when the engaging portion 722 is moved to engage the selected engaging groove 621. Specifically, during braking of the stroller 3, the engaging portion 722 may be moved to engage one of the ribs 620 rather than the engaging grooves 621. Accordingly, by means of the press spring 75 which biases the engaging portion 722 toward the wheel axle 61 with a biasing force, the engaging portion 722 can be easily inserted into the selected engaging groove 621 by a slight rotation of the wheel 62.

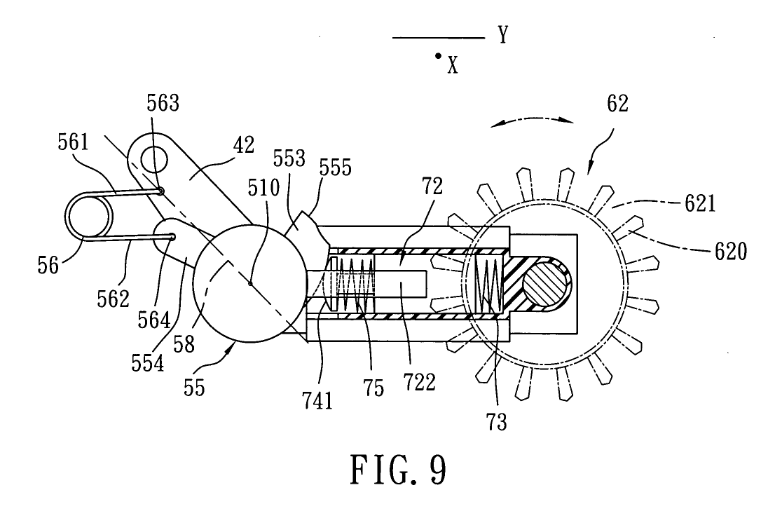

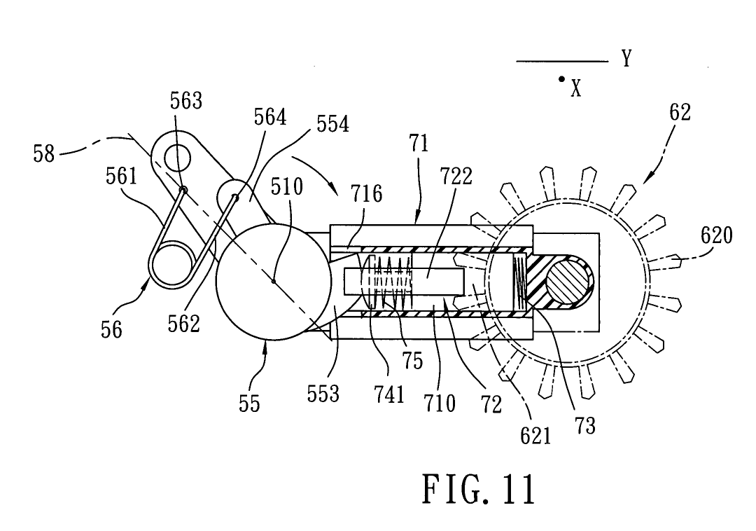

Moreover, when the brake control seat 55 is in the non-actuating position, as shown in FIG. 9, each of the torsion springs 56 is in a first configuration which vests the torsion spring 56 with a first biasing force that biases the brake control seat 55 to the non-actuating position. When the brake control seat 55 is in the actuating position, as shown in FIG. 11, the torsion spring 56 is in a second configuration which vests the torsion spring 56 with a second biasing force that biases the brake control seat 55 to the actuating position. Specifically, the first and second spring ends 561, 562 of the torsion spring 56 are connected to the pivoting lug unit 42 and the spring mounting portion 554 at first and second points 563, 564, respectively. The first point 563 cooperates with a rotating center 510 of the brake control seat 55 to define a line 58. The second point 564 is moved to cross the line 58 when the torsion spring 56 is displaced to thereby transform from the first configuration to the second configuration.

Furthermore, the damping springs 46 are disposed to provide a damping force when the foot-engaging portion 542 of the brake pedal 54 is treaded.

As illustrated, since the pedal unit 5 is largely disposed in the tubular member 41, and since the brake mechanisms 7 have a simple construction, the brake assembly is easy and inexpensive to manufacture and assemble, and has a nice outer appearance.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A stroller comprising:
left and right wheel units which respectively have left and right wheel axles extending along a wheel axis in a longitudinal direction, and left and right wheels rotatably mounted on said left and right wheel axles, respectively;
a mounting frame which is disposed between said left and right wheel axles, and which has a tubular member including a surrounding wall that defines a channel and that extends along a rotating axis parallel to the wheel axis, and an elongate slot that extends through said surrounding wall and that is elongated angularly about the rotating axis;
a linking rod which is rotatably mounted in said channel to be rotated about the rotating axis, and which has two linking ends opposite to each other in the longitudinal direction and extending outwardly of said channel, respectively;
two brake control seats connected respectively to said linking ends to be rotated therewith about the rotating axis;
a brake pedal having a pivot portion which is rotatably mounted on said tubular member, and a foot-engaging portion which extends from said pivot portion in a transverse direction relative to the longitudinal direction;
a coupling member having an inner portion which is disposed in said channel and which extends radially from said linking rod, and an outer portion which extends from said inner portion and outwardly of said surrounding wall through said elongate slot such that treading of said foot-engaging portion forces said outer portion of said coupling member to turn about the rotating axis along said elongate slot so as to synchronously rotate said brake control seats about the rotating axis between a non-actuating position and an actuating position; and
two braking mechanisms, each of which is mounted between a respective one of said brake control seats and a respective one of said left and right wheel axles, and each of which includes a braking member that is disposed to be moved in the transverse direction such that when the respective one of said brake control seats is turned from the non-actuating position to the actuating position, said braking member is moved toward the respective one of said left and right wheels so as to restrain rotation of said left and right wheels relative to said left and right wheel axles.

2. The stroller of claim 1, further comprising two torsion springs, each including first and second spring ends which are respectively connected to said mounting frame and a respective one of said brake control seats, such that when said brake control seats are in the non-actuating position, said torsion springs are in a first configuration which vests said torsion springs with a first biasing force that biases said brake control seats to the non-actuating position, and such that when said brake control seats are in the actuating position, said torsion springs are in a second configuration which vests said torsion springs with a second biasing force that biases said brake control seats to the actuating position.

3. The stroller of claim 2, wherein said first and second spring ends are respectively connected to said mounting frame and the respective one of said brake control seats at first and second points, respectively, said first point cooperating with the rotating axis to define a line, and said second point being moved to cross the line when each of said torsion springs is displaced to thereby transform from the first configuration to the second configuration.

4. The stroller of claim 1, wherein each of said brake control seats includes a peripheral wall surrounding the rotating axis, said braking member having a forced portion and an engaging portion respectively proximate to the respective one of said brake control seats and the respective one of said left and right wheel axles, each of said braking mechanisms further including
a plurality of left engaging grooves disposed in said left wheel, and angularly displaced from one another about the wheel axis,
a plurality of right engaging grooves disposed in said right wheel, and angularly displaced from one another about the wheel axis,
a cam extending radially from said peripheral wall, and having a cam surface which includes first and second areas that are angularly displaced from each other about the rotating axis and that respectively confront said forced portion of said braking member when a respective one of said brake control seats is in the non-actuating position and the actuating position, such that when the respective one of said brake control seats is rotated from the non-actuating position to the actuating position, said cam surface is rotated to force said engaging portion of said braking member to move to be inserted into a selected one of said left and right engaging grooves, and
a press spring disposed between said cam surface and said forced portion of said braking member so as to press said forced portion to move said engaging portion toward the respective one of said left and right wheel axles.

5. The stroller of claim 4, wherein said forced portion includes abutted and abutting ends opposite to each other along a first axis in the transverse direction, each of said braking mechanisms further including a press rod having a pressed end which engages and which is depressable by said cam surface to force said press spring against said abutted end when the respective one of said brake control seats is rotated from the non-actuating position to the actuating position, and a return spring which is disposed between said abutting end and the respective one of said left and right wheel axles, and which biases said abutted end toward said pressed end such that when the respective one of said brake control seats is rotated from the actuating position to the non-actuating position, said pressed end is forced towards the respective one of said brake control seats through said press spring.

6. The stroller of claim 5, wherein said engaging portion is moved along a second axis parallel to the first axis so as to be inserted into the selected one of said left and right engaging grooves when said press spring is forced against said abutted end.

7. The stroller of claim 1, wherein said left and right wheel axles are mounted securely to said mounting frame.

8. The stroller of claim 7, further comprising left and right frame bodies which are opposite to each other in the longitudinal direction and which have left and right pivot portions, respectively, said mounting frame further including left and right pivoting lug units which are mounted on said tubular member and which are respectively proximate to said left and right wheel units so as to be pivotally mounted on said left and right pivot portions, respectively, about a pivot axis in the longitudinal direction.

9. The stroller of claim 8, further comprising two damping springs, each of which is disposed between a respective one of said left and right pivot portions and said mounting frame adjacent to a respective one of said left and right pivoting lug units so as to provide a damping force when said foot-engaging portion of said brake pedal is treaded.

10. The stroller of claim 1, wherein said outer portion of said coupling member is mounted securely to said foot-engaging portion of said brake pedal.

11. The stroller of claim 1, wherein the rotating axis is offset from the wheel axis.
